(19) United States
(12) Patent Application Publication
(10) Pub. No.: US 2015/0015574 A1
(43) Pub. Date: Jan. 15, 2015

(54) SYSTEM, METHOD, AND COMPUTER PROGRAM PRODUCT FOR OPTIMIZING A THREE-DIMENSIONAL TEXTURE WORKFLOW

(71) Applicant: NVIDIA Corporation, Santa Clara, CA (US)

(72) Inventors: Santhanakrishnan Prahalad, Chennai (IN); Sanjid Chogle, Alibad (IN)

(21) Appl. No.: 13/938,166

(22) Filed: Jul. 9, 2013

(51) Int. Cl. G06T 15/04; G06T 17/00

(52) U.S. Cl. CPC G06T 15/04; G06T 17/00
USPC 345/420

(57) ABSTRACT

A system, method, and computer program product for implementing a workflow for generating and editing texture maps is disclosed. The method includes the steps of generating an object in a memory for storing image data corresponding to a texture map associated with a three-dimensional model, launching a two-dimensional image editing application to modify the image data, and updating the texture map in a three-dimensional modeling application based on the modified image data. The step of generating an object in a memory is performed by a plug-in for the three-dimensional modeling application.

### FIELD OF THE INVENTION

The present invention relates to computer graphics, and more particularly to generating texture maps for three-dimensional graphics applications.

### BACKGROUND

Modern applications that implement three-dimensional (3D) graphics are ubiquitous in today's marketplace. Many of today's best-selling games for the personal computer and game consoles utilize 3D graphics to produce the animations shown on a display device. Typically, such applications utilize an application programming interface (API) to generate the images for display using standardized, hardware independent graphics commands transmitted to a driver and processed by a graphics processing unit (GPD). These APIs include OpenGL® and Microsoft's Direct3D®.

In one example, the OpenGL API defines an abstract graphics rendering pipeline that includes the utilization of programmable graphics shaders (e.g., vertex shaders, geometry shaders, and fragment shaders). The vertex shaders specify programs for transforming a set of vertices within graphics primitives (e.g., points, lines, triangles, triangle strips, quads, etc.) defining a 3D model. The geometry shaders specify programs for modifying the 3D model, such as performing tessellation on the graphics primitives to generate additional graphics primitives. The fragment shaders specify programs for texturing and shading pixel fragments (i.e., portions of a graphics primitive that overlap a pixel). In order to select a color for a particular fragment, the fragment shader may include instructions that cause a texture processor to access a texture map (i.e., a bitmap or raster image) to select a color for the fragment based on rasterized texture coordinates included in the vertices of the associated graphics primitive. These texture maps are predefined bitmaps that define an image to be applied to a surface defined by the associated graphics primitive.

Developers of these applications may include a plurality of texture maps in their graphics application. These texture maps may be predefined and included in a standard library for use as textures, or the texture maps may be custom designed by the developer using a variety of image editing applications. In order to define a new texture map, the developer may use an application such as Adobe Photoshop to create the image for the texture map, and then import the image into a 3D modeling application such as Autodesk 3ds Max or Autodesk Maya. The developer can then apply the texture to the model and view a rendering of the model with the applied texture.

Developing 3D models with textured surfaces in this fashion can be tedious. For example, the developer must open a two-dimensional (2D) image editing application to create the texture map. Then the developer exports the image as a texture map, saving the texture map on a storage device such as a filesystem implemented on a hard disk drive. Once the texture map is saved to the filesystem, the developer can open the 3D modeling application and import the texture map from the filesystem. From there, the developer can view a rendering of the model with the texture map applied. However, if the developer wants to modify the texture map in any way, such as by changing the scale of a pattern in the texture map or changing the hue of certain colors in the texture map, then the developer has to open the 2D image editing application, modify the image in the 2D image editing application, export the image as a texture map to the filesystem, import the texture map into the 3D modeling application, apply the modified texture map to the associated surfaces of the model, and then render the model to view the results of any changes made in the 2D image editing application on the rendering of the 3D model. The use of the two applications is tedious and time consuming. Thus, there is a need for addressing this issue and/or other issues associated with the prior art.

### SUMMARY

A system, method, and computer program product for implementing a workflow for generating and editing texture maps is disclosed. The method includes the steps of generating an object in a memory for storing image data corresponding to a texture map associated with a 3D model, launching a 2D image editing application to modify the image data, and updating the texture map in a 3D modeling application based on the modified image data. The step of generating an object in a memory is performed by a plug-in for the 3D modeling application.

### BRIEF DESCRIPTION OF THE DRAWINGS

FIG. 1 illustrates a flowchart of a method for creating and editing texture maps, in accordance with one embodiment;

FIG. 2 illustrates a system for creating and editing texture maps, in accordance with the prior art;

FIG. 3 illustrates a system for creating and editing texture maps, in accordance with one embodiment;

FIG. 4 is a conceptual diagram of a texture map associated with a graphics primitive, in accordance with one embodiment;

FIGS. 5A and 5B illustrate a flowchart of a method for creating and editing texture maps, in accordance with another embodiment; and

FIG. 6 illustrates an exemplary system in which the various architecture and/or functionality of the various previous embodiments may be implemented.

### DETAILED DESCRIPTION

The present disclosure describes a plugin or tool for a 3D modeling application that enables a developer to edit a texture map natively within the 3D modeling application. The plugin creates an object in the memory for storing the image data associated with the texture map and then opens a 2D image editing application to modify the image data in the object. Modifications to the image data may be reflected in the 3D modeling application in real-time, such as by rendering a new image of the 3D model with the modified texture map image data applied to one or more surfaces of the model as changes are made to the image data. Using the plugin, the texture map data is passed between the 2D image editing application and the 3D modeling application via the system memory rather than requiring the texture map to be exported to the filesystem and then imported into the 3D modeling application as separate and distinct steps manually implemented by the developer. The above features may or may not be exploited in the context of the various embodiments set forth below.

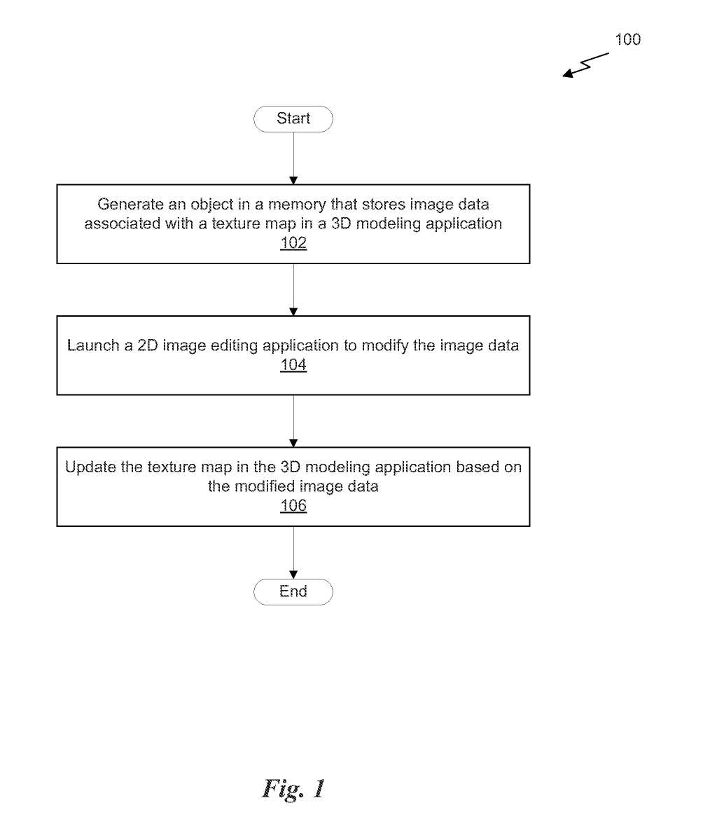

FIG. 1 illustrates a flowchart of a method 100 for creating and editing texture maps, in accordance with one embodiment. The method 100 may represent a texture work flow implemented by a developer of a 3D graphics application. At step 102, an object is generated in a memory. In the context of the present description, the object is a data structure that stores data associated with a texture map in a volatile memory. In one embodiment, image data associated with a texture map associated with a 3D model may be copied into the object. At step 104, a 2D image editing application is launched to enable a developer to modify the image data in the object. In the context of the present description, the 2D image editing application may be any application, executed by a processor, which is capable of modifying image data (e.g., pixel data in a RGBA format). At step 106, the texture map is updated based on the modified image data. The texture map may be stored in a data structure implemented by a 3D modeling application. In the context of the present description, the 3D modeling application may be any application, executed by a processor, which is capable of modifying a 3D model that is a collection of vertices in a 3D model space and any associated vertex attributes as well as other information necessary for rendering or animating the 3D model.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

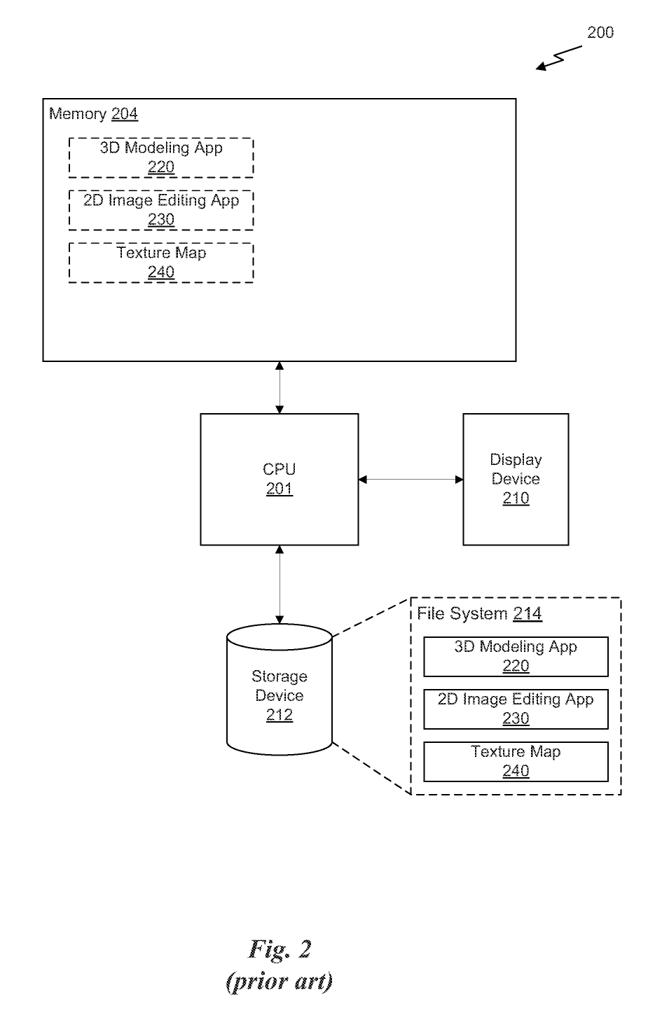

FIG. 2 illustrates a system 200 for creating and editing texture maps, in accordance with the prior art. As shown in FIG. 2, a developer may create and/or edit texture maps using a system 200. The system 200 includes a processor 201, a memory 204, a display device 210, and a storage device 212. The processor 201 is a central processing unit (CPU) such as an Intel x86 type of processor. The processor 201 is coupled to the memory 204, which may be a synchronous dynamic random access memory (SDRAM) or some other type of volatile storage device. The display device 210 is a conventional display device such as a liquid crystal display (LCD) or a LCD with a backlit light emitting diode (LED) array. The display device 210 is capable of displaying image data on a surface of the display device. In one embodiment, the display device 210 may be coupled to a GPU (not shown) that acts as a co-processor to the processor 201 and generates image data for display on the display device 210. The storage device 212 may be a hard disk drive or some other type of non-volatile storage. In various embodiments, the storage device 212 may be a hard disk-drive, a solid state storage device, a Flash memory device, a cloud-based service accessed via a network interface controller (NIC) such as Amazon® S3, or the like. The storage device 212 may implement a filesystem 214, such as NTFS, FAT32, or the like that enables files to be stored on the storage device 212 and accessed by various applications executed by the processor 201.

In one embodiment, the system 200 includes at least one version of a 3D modeling application 220 installed on the storage device 212 and loaded into the memory 204 for execution by the processor 201. The 3D modeling application 220 may be any application configured to generate and/or edit a 3D model. The 3D model is a collection of graphics primitives such as lines, vertices, triangles, surfaces and the like. The 3D modeling application 220 may include one or more tools for generating and/or editing a 3D model, generating and/or editing animations with the 3D model, and rendering images of the 3D model with the graphics primitives shaded or textured as well as adding lighting and/or other effects. In one embodiment, the 3D modeling application 220 may be any conventional 3D modeling application such as Autodesk® 3ds Max or Autodesk® Maya.

The system 200 also includes at least one version of a 2D image editing application 230 installed on the storage device 212 and loaded into the memory 204 for execution by the processor 201. The 2D image editing application 230 may be any application configured to generate and/or modify digital images. Digital images may include bitmaps or raster images in one or more formats including compressed formats such as JPEG (Joint Photographic Experts Group). The 2D image editing application 230 may include one or more tools for generating and/or editing digital images, adding effects (such as a blur or other type of filter) to the digital images, and exporting or compressing the digital images to particular formats. In one embodiment, the 2D image editing application 230 may be any conventional 2D image editing application such as Adobe® Photoshop or GIMP (the GNU Image Manipulation Program).

One example of a workflow for generating and/or editing texture maps using the prior art system 200 is described below. The 3D modeling application 220, installed on the storage device 212 and loaded temporarily into the memory 204, is launched and executed by the processor 201. A developer generates or opens a 3D model in the 3D modeling application 220. The 3D model may include one or more surfaces that the developer wishes to associate with a particular texture map. A file 240 including a texture map to apply to the one or more surfaces may be selected from the storage device 212 and loaded into the memory 204. In some cases, the developer may want to apply a custom texture map that is not located in the storage device 212. In these cases, the developer may export a default texture map from the 3D modeling application 220 that is stored as a file 240 in the storage device 212. In order to store the new texture map on the storage device 212, the 3D modeling application 220 accesses a file system 214 maintained by the operating system executed by the processor 201. Once the file 240 has been created, the developer may launch the 2D image editing application 230, which is also installed on the storage device 212 and loaded temporarily into the memory 204. The developer may then import the custom texture map in the 2D image editing application 230 by locating and selecting the file 240 created by the 3D modeling application 220 in the file system 214. Once the 2D image editing application 230 has opened the digital image associated with the custom texture map, the developer may edit the digital image using one or more tools of the 2D image editing application 230. Once the developer is content with the state of the modified digital image, the developer may store the contents of the modified digital image in the file 240 or may generate a new file in the file system 214 that includes the image data corresponding to the modified digital image. The developer may then import the customized texture map to apply to the one or more surfaces of the 3D model using the 3D modeling software 220 by locating and selecting the file 240 created by the 2D image editing application 230 in the file system 214. The developer may then use one or more tools in the 3D modeling application 220 to apply the customized texture map to the one or more surfaces of the 3D model.

It will be appreciated that the prior art workflow is tedious and time consuming for the developer. The developer must independently load and execute both the 3D modeling application 220 and the 2D image editing application 230. Furthermore, the developer must manually pass the digital image data between the two independent applications using files stored in the file system 214, first outputting a file (or updating a file) from one of the applications and then locating and selecting that file from the other application. This is time consuming at best and may lead to confusion as the developer maintains large numbers of different texture maps (i.e., files) in the same file system for a particular project (i.e., the developer may overwrite a file that the developer did not intend to overwrite, the developer may select the wrong file when importing the data into one of the applications, etc.). Thus, a better solution for generating and/or editing texture maps is needed.

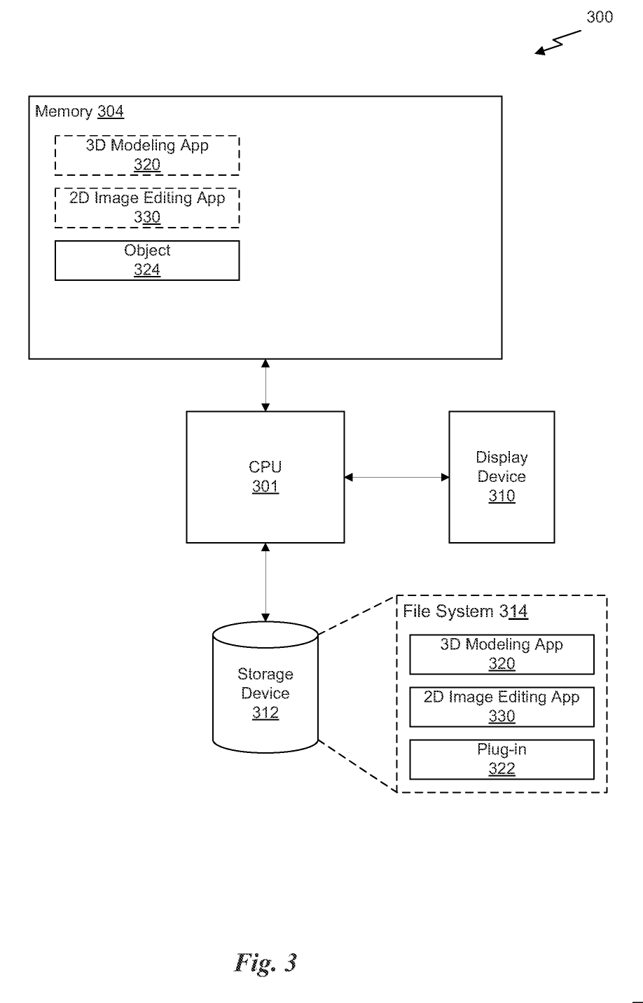

FIG. 3 illustrates a system 300 for creating and editing texture maps, in accordance with one embodiment. As shown in FIG. 3, the system 300 includes a processor 301, a memory 304, and a display device 310 similar to the processor 201, the memory 204, and the display device 210 of FIG. 2, respectively. The system 300 also includes a 3D modeling application 320 and a 2D image editing application 330 similar to the 3D modeling application 220 and the 2D image editing application 230 of FIG. 2, respectively. Although system 300 may include a file system 314 on a storage device 312 (similar to storage device 212) for storing the 3D modeling application 320 and the 2D image application 330, which are then temporarily loaded into the memory 304 for execution by the processor 301, the system 300 does not utilize the file system on the storage device 312 for passing data between the 3D modeling application 320 and the 2D image editing application 330 to generate and/or edit texture maps. Instead, the workflow for generating and/or editing texture maps using the system 300 is described below.

The 3D modeling application 320, installed on the storage device 312 and loaded temporarily into the memory 304, is launched and executed by the processor 301. A developer generates or opens a 3D model in the 3D modeling application 320. The 3D model may include one or more surfaces that the developer wishes to associate with a particular texture map. The developer may select a plug-in 322 associated with the 3D modeling application 320 in order to generate and/or edit the texture map for the one or more surfaces. The plug-in 322 may be an application extension (i.e., program configured to be executed from within the 3D modeling application 320) that is configured to enable the developer to edit the texture map from within the 3D modeling application 320. The plug-in 322 may be stored in the file system 314 of the storage device 312 and loaded into the memory 304 for execution by the processor 301. The plug-in 322, when selected by the developer, may be configured to generate an object 324 in the memory 304 and launch the 2D image editing application 330. The plug-in 322 may include configuration settings that indicate a location in the file system 314 that is associated with the 2D image editing application 330 such that the plug-in 322 can copy the file for the 2D image editing application 330 into the memory 304 and launch the 2D image editing application 330. The object 324 is a data structure that is stored in a portion of the memory 304 allocated to the 3D modeling application 320 for passing data between the 3D modeling application 320 and the 2D image editing application 330. The object 324 may include the image data corresponding to the texture map associated with the one or more surfaces that the developer has selected for generation/editing.

In one embodiment, the object 324 includes a 2D array of image data that represents the digital image corresponding to the texture map. Each entry in the 2D array of image data may correspond to one pixel of the digital image. In some embodiments, the object 324 may also include additional data passed between the 3D modeling application 320 and the 2D image editing application 330. For example, the applications may pass messages (e.g., commands, data, etc.) that inform the other application that a command has been executed by the application issuing the message, or the applications may pass messages that request the other application to execute a command.

Once the object 324 has been generated in the memory 304 and the 2D image editing application 330 has been launched, the plug-in 322 causes the 2D image editing application 330 open the object 324 for editing, The 2D image editing application 330 may include a window that shows the digital image represented by the image data included in the object 324. The developer may then use one or more tools included in the 2D image editing application 330 to modify the image data included in the object 324. As the image data is modified, the texture map associated with the one or more surfaces in the 3D modeling application 320 may be updated in real-time. For example, after each command executed by the developer in the 2D image editing application 330, the plug-in 322 may be configured to determine whether the image data in the object 324 has been modified. If the image data has not been modified, then the plug-in 322 may be configured to wait until another command is executed by the developer in the 2D image editing application 330. However, if the image data has been modified, then the plug-in 322 may be configured to execute one or more commands in the 3D modeling application 320. For example, if a window in the 3D modeling application 320 displays a rendering of the 3D model with the texture map applied to one or more surfaces, the plug-in 322 may be configured to execute a command that causes the 3D modeling application 320 to re-render the image of the 3D model using a modified texture map that includes the modified image data from the object 324.

Once the developer has completed editing the texture map in the 2D image editing application 330, the developer may close the 2D image editing application 330. In response to the developer closing the 2D image editing application 330, the plug-in 322 may update the texture map within the 3D modeling application 320 based on the modified image data in the object 324. Once the texture map has been updated in the 3D modeling application 320, the plug-in 322 may release the memory allocated for the object 324 and the plug-in 322 may exit. When the user saves the work associated with the 3D model, the texture map may be stored in the file system 314 of the storage unit 312 along with the data for the 3D model.

It will be appreciated, that the plug-in 322 automatically performs many of the tasks previously performed manually by the developer. For example, the plug-in 322 does not require the developer to export a texture map from the 3D modeling application 320 to a file in the file system 314 of the storage device 312 to transfer the texture map to the 2D image editing application 330. Instead, the plug-in 322 automatically requests a portion of the memory 304 to be allocated for the object 324. The image data for the texture map is then copied by the plug-in 322 into the allocated space in the object 324. Once the image data has been stored in the object 324, the plug-in 322 launches the 2D image editing application 330 and opens a window in the 2D image editing application 330 for the user to edit the image data using the tools in the 2D image editing application 330. In addition, the plug-in 322 does not require the developer to export the image data from the 2D image editing application 330 to a file in the file system 314 of the storage device 312 to transfer the image data back to the 3D modeling application 320. Instead, the 2D image editing application 330 modifies the image data in the object 324 directly and, when the developer has finished editing the image data, the plug-in 322 copies the modified image data back into the texture map included in the 3D model of the 3D modeling application 320. All of these tasks were previously manually performed by a developer, thereby making development of texture maps inefficient. The plug-in 322 creates a way to link the 3D modeling application 320 with the 2D image editing application 330 such that the workflow for generating and/or editing texture maps using the 2D image editing application 330 can be performed by passing data between the applications using the local system memory 304 (i.e., a volatile memory) without temporarily storing the data in the file system 314 of the storage device 312.

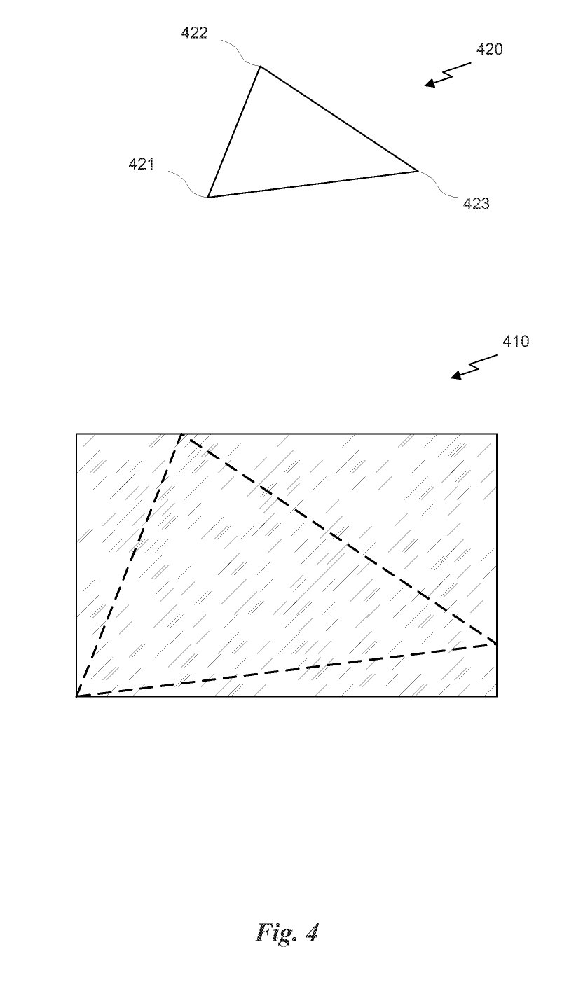

FIG. 4 is a conceptual diagram of a texture map 410 associated with a graphics primitive 420, in accordance with one embodiment. As shown in FIG. 4, the graphics primitive 420 is a triangle having three vertices 421, 422, and 423 in a 3D model space. The 3D model space may have a defined origin as well as 3 orthogonal axes defined as an x-axis, a y-axis, and a z-axis. Each of the three vertices 421, 422, and 423 may be associated with a location in the 3D model space defined by an x-coordinate, a y-coordinate, and a z-coordinate. By locating the three vertices 421, 422. and 423 associated with the graphics primitive 420 in the 3D model space, the graphics primitive 420 defines a triangle including all points on a plane inside the three edges defined by lines that intersect each corresponding pair of vertices.

In one embodiment, when the graphics primitive 420 is rendered, the 3D graphics primitive 420 is rasterized. Rasterization may be defined as projecting the 3D graphics primitive 420 onto a viewing plane such that the 3D graphics primitive 420 is converted to a 2D representation of the 3D graphics primitive 420. In other words, the viewing plane may be defined as a 2D array of pixels corresponding to a digital image to be displayed on a display device. For each pixel in the 2D array of pixels, one or more rays are intersected with the graphics primitive 420 to determine whether the graphics primitive 420 contributes to the final rendered color for the pixel. If the ray intersects the graphics primitive 420, then a color of the graphics primitive at the point intersected by the ray is determined and blended with a color for the pixel stored in a color buffer.

The color of the graphics primitive 420 at a particular location on the surface of the graphics primitive 420 may be determined based on vertex attributes included in the graphics primitive 420. For example, each of the three vertices 421, 422, and 423 may include a color attribute (e.g., four 32-bit single precision floating-point values for each of four color channels for the vertex: Red, Green, Blue, and Alpha) that represents the color of the graphics primitive 420 at that vertex. The rendering pipeline (i.e., the set of processes implemented to render the image) may then interpolate the color at a particular point on the surface of the graphics primitive 420 based on the colors at the three vertices 421, 422, and 423.

One alternative to selecting a color based on the color attributes of the vertices is to apply a texture map 410 to the surface of a graphics primitive 420. Again, a texture map 410 is a bitmap or raster image that represents a digital image to apply to the surface of the graphics primitive. Instead of performing a linear interpolation between, e.g., three colors associated with the three vertices of the graphics primitive 420, the texture map 410 is sampled to determine the color associated with a particular point on the surface of the graphics primitive 420. For example, the texture map 410 may include image data that represents the surface of a brick, For any graphics primitive 420 associated with a brick wall, the texture map 410 may be applied to the surface of the graphics primitive 420 such that the rendered image of the graphics primitive 420 appears to be the surface of a brick.

The texture map 410 is sampled based on an interpolated value of texture coordinates associated with the three vertices 421, 422, and 423 of the graphics primitive 420. Each vertex may be associated with one or more texture coordinates (e.g., u, v, s, t, etc.) that enable the rendering pipeline to sample particular pixels of the texture map 410 to generate the color value for the pixel. In one embodiment, each vertex of the graphics primitive includes two texture coordinates, a u-coordinate associated with a horizontal axis of the texture map 410 and a v-coordinate associated with a vertical axis of the texture map 410. In one embodiment, each of the texture coordinates is a 32-bit single precision floating-point value between 0.0 and 1.0 that represents a point along a corresponding axis between a minimum coordinate for the axis (i.e., 0.0) and a maximum coordinate for the axis (i.e., 1.0), For example, the first vertex 421 of the graphics primitive 420 may include a u-coordinate of 0.0 and a v-coordinate of 1.0, representing the lower left pixel of the texture map 410; the second vertex 422 of the graphics primitive 420 may include a u-coordinate of 0.25 and a v-coordinate of 0.0; and the third vertex 423 of the graphics primitive 420 may include a u-coordinate of 1.0 and a v-coordinate of 0.8. The projection of the graphics primitive 420 onto the texture map 410 is shown in FIG. 4. In one embodiment, the texture map 410 is sampled at multiple locations in order to generate a sample value from the texture map 410. Although both the graphics primitive 420 and the texture map 410 are shown from the perspective of the viewing plane, the graphics primitive 420 may be skewed with respect to the perspective of the texture map. In such cases, the texture map 410 may be sampled using various anti-aliasing techniques to avoid image artifacts from showing up in the rendered image.

It will be appreciated that the explanation of applying a texture map 410 to a graphics primitive 420, described above, is only one possible technique for implementing texture maps in the rendering pipeline. Other techniques for rendering a 3D model using texture maps are well-known to one of skill in the art and are contemplated as being within the scope of the present disclosure.

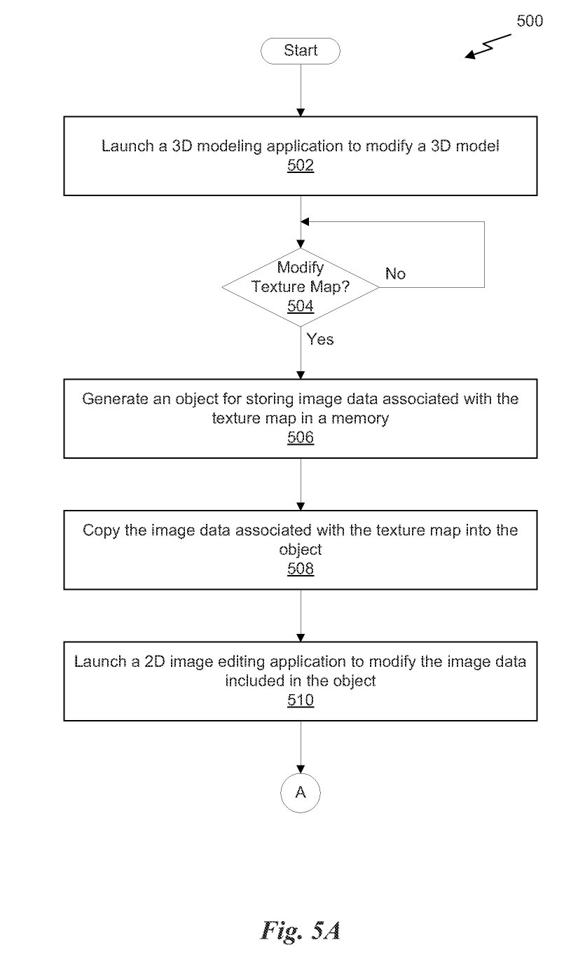

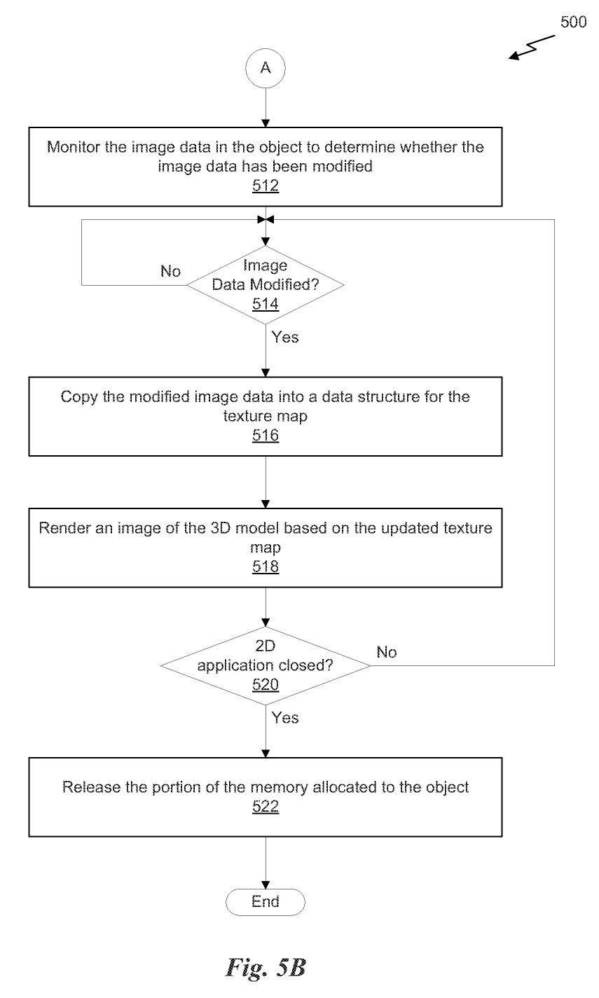

FIGS. 5A and 5B illustrate a flowchart of a method 500 for creating and editing texture maps, in accordance with another embodiment. At step 502, a developer selects a 3D modeling application 330 to be launched by a processor 301 to modify a 3D model. The 3D modeling application 330 is executed by the processor and a window may display one or more tools for editing the 3D model. At step 504, the 3D modeling application 320 may determine whether a developer wants to modify a texture map 410 associated with the 3D model. In one embodiment, the developer may select a command within the 3D modeling application 320 that indicates the developer wants to modify a texture map 410. The command may cause the 3D modeling application 320 to launch a plug-in 322 to enable the developer to modify the texture map using a 2D image editing application 330. If the developer has not indicated that the developer wants to modify the texture map 410, then the method 500 waits until the developer indicates that the developer wants to modify the texture map 410 (e.g., by selecting a command to edit a texture map).

However, if the developer has indicated that the developer wants to modify the texture Imp 410, then, at step 506, the 3D modeling application 320 may launch a plug-in 322 that is configured to generate an object 340 for storing image data associated with the texture map 410 in a memory 304. At step 508, the plug-in 322 copies the image data associated with the texture map 410 into the object 324. At step 510, the plug-in 322 launches a 2D image editing application 330 to enable the developer to modify the image data in the object 324.

At step 512, the plug-in 322 monitors the image data in the object to determine whether the image data has been modified. At step 514, the plug-in 322 determines whether the image data has been modified. In one embodiment, the plug-in 322 generates a check-sum of the image data periodically. If the check-sum associated with the image data has changed, then the plug-in 322 determines that the image data has been modified. In another embodiment, the plug-in 322 receives a message from the 2D image editing application 330 whenever the image data has been modified by the 2D image editing application 330, The message may be written to a portion of the object 324 by the 2D image editing application 330 and read from the object by the plug-in 322. If the plug-in 322 determines that the image data has not been modified, then the plug-in returns to step 514 and waits for the image data to be modified. However, if the plug-in 322 determines that the image data has been modified, then, at step 516, the plug-in copies the modified image data into a data structure for the texture map 410 in the memory 304. The 3D modeling application 320 may maintain a data structure for each texture map 410 associated with at least one surface of the 3D model. At step 518, the plug-in 322 may cause the 3D modeling application 320 to render an image of the 3D model based on the updated texture map.

At step 520, the plug-in 322 determines whether the 2D image editing application 330 has been closed by the developer. If the 2D image editing application 330 has not been closed, then the method 500 returns to step 514 where the plug-in 322 waits for the image data to be modified again. However, if the 2D image editing application 330 has been closed, then, at step 522, the plug-in 322 releases the portion of the memory 304 allocated to the object 324 to be reused by the memory system. After step 522, the method 500 terminates.

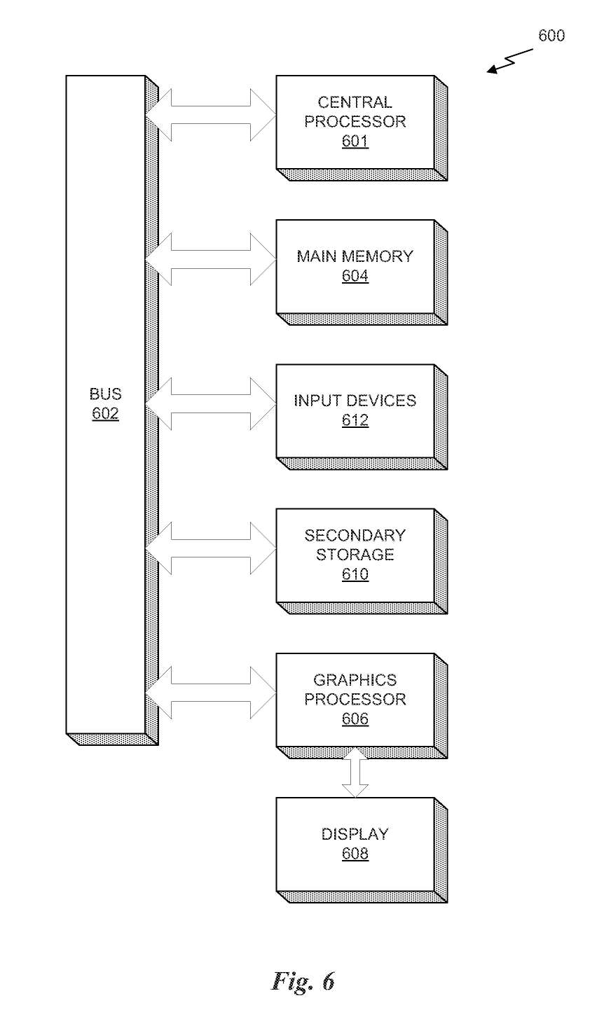

FIG. 6 illustrates an exemplary system 600 in which the various architecture and/or functionality of the various previous embodiments may be implemented. As shown, a system 600 is provided including at least one central processor 601 that is connected to a communication bus 602. The communication bus 602 may be implemented using any suitable protocol, such as PCI (Peripheral Component Interconnect), PCI-Express, AGP (Accelerated Graphics Port), Hyper Transport, or any other bus or point-to-point communication protocol(s). The system 600 also includes a main memory 604. Control logic (software) and data are stored in the main memory 604 which may take the form of random access memory (RAM). In one embodiment, the system 600 may be utilized to implement the system 300 described above.

The system 600 also includes input devices 612, a graphics processor 606, and a display 608, i.e. a conventional CRT (cathode ray tube), LCD (liquid crystal display), LED (light emitting diode), plasma display or the like. User input may be received from the input devices 612, e.g., keyboard, mouse, touchpad, microphone, and the like. In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 604 and/or the secondary storage 610. Such computer programs, when executed, enable the system 600 to perform various functions. The memory 604, the storage 610, and/or any other storage are possible examples of computer-readable media.

In one embodiment, the architecture and/or functionality of the various previous figures may be implemented in the context of the central processor 601, the graphics processor 606, an integrated circuit (not shown) that is capable of at least a portion of the capabilities of both the central processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, laptop computer, server, workstation, game consoles, embedded system, and/or any other type of logic. Still yet, the system 600 may take the form of various other devices including, but not limited to a personal digital assistant (PDA) device, a mobile phone device, a television, etc.

Further, while not shown, the system 600 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments. but should be defined only in accordance with the following claims and their equivalents.

What is claimed is:

1. A method comprising:
generating, by a plug-in for a three-dimensional (3D) modeling application, an object in a memory for storing image data corresponding to a texture map associated with a 3D model;
launching a two-dimensional (2D) image editing application to modify the image data; and
updating the texture map in the 3D modeling application based on the modified image data.

2. The method of claim 1, wherein the memory is a synchronous dynamic random access memory (SDRAM).

3. The method of claim 1, wherein the texture map is a bitmap image.

4. The method of claim 1, wherein the texture map comprises a 2D array of image data.

5. The method of claim 1, further comprising:
receiving, by the plug-in, a command to edit the texture map associated with the 3D model; and
executing a file at a location specified by a configuration setting of the plug-in to launch the 2D image editing application.

6. The method of claim 1, further comprising exporting the texture map from the 3D modeling application by copying the image data corresponding to the texture map into the object

7. The method of claim 1, wherein the 3D modeling application comprises one or more tools for editing a 3D model, editing animations with the 3D model, or rendering images of the 3D model.

8. The method of claim 1, wherein the 2D image editing application comprises one or more tools for editing digital images, adding effects or filters to digital images, or exporting digital images in a particular format.

9. The method of claim 1, further comprising monitoring the object to determine when the image data has been modified by the 2D image editing application, wherein updating the texture map based on the modified image data is performed in response to determining that the image data has been modified.

10. The method of claim 1, wherein updating the texture map in the 3D modeling application comprises copying the modified image data into a data structure for the texture map stored in the memory.

11. The method of claim 1, further comprising rendering a digital image based on the updated texture map.

12. The method of claim 1, further comprising:
determining that the 2D image editing application has been closed; and
releasing a portion of the memory allocated to the object.

13. A non-transitory computer-readable storage medium storing instructions that, when executed by a processor, cause the processor to perform steps comprising:
generating, by a plug-in for a three-dimensional (3D) modeling application, an object in a memory for storing image data corresponding to a texture map associated with a 3D model;
launching a two-dimensional (2D) image editing application to modify the image data; and
updating the texture map in the 3D modeling application based on the modified image data.

14. The non-transitory computer-readable storage medium of claim 13, the steps further comprising:
receiving, by the plug-in, a command to edit the texture map associated with the 3D model; and
executing a file at a location specified by a configuration setting of the plug-in to launch the 2D image editing application.

15. The non-transitory computer-readable storage medium of claim 13, the steps further comprising monitoring the object to determine when the image data has been modified by the 2D image editing application, wherein updating the texture map based on the modified image data is performed in response to determining that the image data has been modified.

16. A system, comprising:
a memory storing an instance of a three-dimensional (3D) modeling application and an instance of a two-dimensional (2D) image editing application; and
a processor coupled to the memory and configured to:
generate, by a plug-in for the 3D modeling application, an object in a memory for storing image data corresponding to a texture map associated with a 3D model,
launch the 2D image editing application to modify the image data, and
update the texture map in the 3D modeling application based on the modified image data.

17. The system of claim 16, further comprising:
a display device for displaying graphical user interfaces for the 3D modeling application and the 2D image editing application; and
a storage device for storing copies of the 3D modeling application and the 2D image editing application in anon-volatile memory.

18. The system of claim 16, wherein the memory further stores an instance of a plug-in associated with the 3D modeling application.

19. The system of claim 18, the processor further configured to:
receive, by the plug-in, a command to edit the texture map associated with the 3D model; and
execute a the at a location specified by a configuration setting of the plug-in to launch the 2D image editing application.

20. The system of claim 19, the processor further configured to monitor the object to determine when the image data has been modified by the 2D image editing application, wherein updating the texture map based on the modified image data is performed in response to determining that the image data has been modified.
